(19) United States
(12) Patent Application Publication
(10) Pub. No.: US 2026/0175310 A1
(43) Pub. Date: Jun. 25, 2026

(54) AUTOMATED ARC WELDING FILLER ROD FEEDING ASSEMBLY AND ARC LENGTH CONTROL

(71) Applicant: Michael S. Brendel, Snoqualmie, WA (US)

(72) Inventor: Michael S. Brendel, Snoqualmie, WA (US)

(21) Appl. No.: 19/422,247

(22) Filed: Dec. 16, 2025

Related U.S. Application Data
(60) Provisional application No. 63/834,382, filed on Dec. 19, 2024.

(51) Int. Cl. B23K 9/12; B23K 9/133

(52) U.S. Cl. CPC B23K 9/124; B23K 9/1336

(57) ABSTRACT

Automated welding filler rod feeding assemblies for use with a handheld welding torch is provided. The filler rod feeding assembly can include a main body having a central opening; a coupling cover removably couplable to the main body and including a capturing surface such that when the coupling cover is assembled to the main body, the capturing surface together with central opening at least partially surround and retain the handheld welding torch therein; and a rod feeding assembly operably coupled to the main body. The rod feeding assembly can include filler rod support tubes, a drive gear abutting the filler rod, and an idler gear imparting a biasing force against the filler rod toward the drive gear. Rotation of the drive gear by a drive motor can cause the filler rod to advance axially through the rod support tubes toward an electrode tip of the handheld welding torch.

### BACKGROUND

Arc welding is widely used processes in the fabrication, construction, repair, and manufacturing industries. Arc welding involves the use of an electric arc to melt and fuse metals at the joint, producing a strong, continuous bond. The arc is generated between an electrode and the base material, with temperatures high enough to melt most commercially used metals. Depending on the type of arc welding process, the electrode may be consumable, as in Shielded Metal Arc Welding, or non-consumable, as in Gas Tungsten Arc Welding, and shielding gas or flux may be employed to protect the molten weld pool from atmospheric contamination.

Gas Tungsten Arc Welding (GTAW) is an is an arc welding process which uses a non-consumable tungsten electrode to produce the weld (also referred to as TIG welding). The electrode and weld area are protected from contaminants in the environment by an inert shielding gas (e.g., argon or helium), and a filler rod is typically used producing the weld bead. Manual GTAW is a difficult welding method which requires a significant level of coordination by the welder. Manual GTAW methods generally require both hands of the welder, with the welder feeding the filler metal into the molten pool with one hand, while using the other hand to manipulate the torch and maintain a constant arc length. In GTAW, it is typically desirable to maintain a short and consistent arc length (i.e., the distance between the tip of the electrode and the work surface), while simultaneously preventing contact between the electrode and the workpiece, which causes contamination. These combined requirements of a consistent arc length and precision application of the filler material make manual GTAW a difficult manufacturing process for a welder to perform, compounded by operator fatigue and out-of-position welding situations with limited options to stabilize movements against the workpiece.

Manual GTAW has the drawbacks noted above, and also typically includes a slower welding speed, higher cost, and the need for greater operator skill compared to other welding methods. The embodiments of the present disclosure are expected to address these and other needs.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 is a side view of an automated welding filler rod feeding assembly operably coupled to a handheld Gas Tungsten Arc Welding (GTAW) torch in accordance with embodiments of the present disclosure; and

FIGS. 2A-2C are perspective views and FIG. 2D is a bottom view of the automated welding filler rod feeding assembly of FIG. 1 for the handheld GTAW torch in accordance with the present disclosure, shown with a filler rod extending through the automated welding filler rod feeding assembly.

### DETAILED DESCRIPTION

The detailed description set forth below in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed.

The present disclosure relates to an automated welding filler rod feeding assembly that can be operably coupled to a handheld welding torch, such as a Gas Tungsten Arc Welding (GTAW) torch, among others. GTAW involves the use of an electric arc to melt and fuse metals at the joint, producing a strong, continuous bond. In each welding type, a filler rod (also referred to herein as “wire”) is applied to the weld to meld with the metal of the workpiece and create the weld bead. During the welding process for GTAW, the filler rod is fed into the molten pool of the weld (created by the arc), creating the weld bead. Embodiments of the present disclosure include an automated welding filler rod feeding assembly that can be used to automatically apply the filler rod into the molten pool of the weld as the handheld welding torch traces along the weld seam. In these embodiments, the filler rod can be any suitable diameter, length, and material, and the feed speed can be adjusted to suit the weld requirements.

The automated welding filler rod feeding assemblies of the present disclosure can be operably coupled to a handheld GTAW torch to permit the use of straight length weld filler rods in diameters larger than those available and fed from coiled spools required with manual GTAW methods of the current technology. The automated welding filler rod feeding assemblies permit increases in the deposition size of handheld GTAW welds, and increase manufacturing flexibility in filler rod alloy and/or diameter choice, while decreasing overall operating setup costs (e.g., only a single straight length of filler rod is needed to perform a weld, rather than an entire spool). In these regards, the embodiments of the automated welding filler rod feeding assembly are expected to provide several advantages over the current technology, including lower initial cost, broad material thickness, insensitivity to material properties, increased penetration depth, improved safety, and less specialized training for welding technicians.

Using the automated welding filler rod feeding assemblies of the present disclosure with a handheld GTAW torch provides increased stability and ease of control to the tungsten-to-part arc length. In some embodiments, the automated welding filler rod feeding assemblies can be operably coupled to the GTAW torch (e.g., a TIG torch), and the filler rod can be positioned by the feeding assembly to provide a resting feature for the GTAW torch while the welding operator traces along the weld path. In this regard, the weight of the GTAW torch, feeding assembly, and filler rod can generally be supported by the filler rod atop the workpiece, permitting the welding operator to precisely control the arc length, improving weld joint consistency and performance. In some embodiments, the automated welding filler rod feeding assemblies can provide automation to the filler rod feed rate, which corresponds to the weld travel rate (i.e., the speed along the weld path).

The automated welding filler rod feeding assemblies of the present disclosure can be configured to operate in conjunction with a wide variety of welding torch types, brands, and sizes, and can be used with various filler rod alloys and diameters. The coupling components of the feeding assembly can be configured to accommodate GTAW torch/TIG torches of different designs/configurations and/or from different manufacturers, making the feeding assembly suitable for use with new or in-service weld torches. As will be described in detail below, the rod feeding components of the automated welding filler rod feeding assemblies can be adjusted to accommodate the difference filler rod alloys and diameters, and in this regard feed wheel pressure can be adjusted such that the filler rod feed speed corresponds to the desired weld path speed, which can be based on alloy, weld depth, bead height, etc. As such, welding personnel have precise control over the feeding assembly to accommodate the desired weld characteristics.

The automation of the previously manual welding process and improved control of weld characteristics using embodiments of the present disclosure are expected to provide several advantages over conventional technology. In an embodiment, weld bead size, weld path speed, heat input per linear inch, and other aspects can be automated for full control, rather than dependence on welding operator skill. In addition, at least some of the expensive and time-consuming post-weld inspections on heat-sensitive base alloys can be avoided. As the welding processes using the embodiments described herein can be considered semi-automated, rather than fully manual, the qualification/skill of welding operators can be lower, while still complying with welding codes. Other advantages are also expected.

Although embodiments of the present disclosure may be described with reference to standard GTAW torches, one skilled in the relevant art will appreciate that the disclosed embodiments are illustrative in nature and therefore should not be construed as limited to such an application. It should therefore be apparent that the disclosed technologies and methodologies have wide application, and therefore may be suitable for use with many types of handheld welding apparatuses, including different brands and various configurations, sizes, and performance levels, etc. The embodiments shown in the FIGURES may omit common components for clarity in the drawings, such as power and gas supplies, gas roads, water ways, collimators, lenses, mirrors, electrodes, insulators, electrical wiring, etc. Details of the welding torches are also omitted herein, where applicable, to ensure clarity in the ensuing description. Accordingly, the following descriptions and illustrations herein should not limit the scope of the claimed subject matter.

As will be described in more detail below, the present disclosure provides examples of automated welding filler rod feeding assemblies that provide automatic feeding of welding filler rod to a molten pool of the weld (created by the arc), extending across the weld seam and creating the weld bead. When the feeding assembly is activated, for example, by a remote switch (e.g. a foot switch), or other type of activation, a drive motor of the feeding assembly pushes the filler rod toward the molten pool (weld puddle) at the programmed rate. In this regard, embodiments of the present disclosure can be electronically coupled to a controller (not shown) that can send signals to and receive signals from the drive motor of the feeding assembly. The welding personnel can program a feed rate setting that is suitable for the type of weld, the weld depth, the filler rod alloy, etc. For example, the feed rate can range from about 3 inches/minute to about 30 inches/minute; however, other feed rates are also within the scope of the present disclosure. The filler rod feed can be a constant speed or pulsed.

As set forth above, the filler rod can be placed in contact with the work surface during the welding operation. In this regard, the filler rod can provide support to the GTAW torches, the feeding assembly, and the hand of the welder while the welding operator performs the welding operation. For example, in GTAW, arc length control is a critical component of weld quality and performance. Using current technology GTAW, the operator is required to hold the GTAW torch above the weld at a precise distance to control the arc length, while feeding the filler rod manually into the molten pool of the weld, require significant precision and training. Embodiments of the present disclosure can enable the use of the filler rod to rest the assembly and welding components on the workpiece during the welding operation, controlling the distance from the electrode to the work surface (arc gap), which provides precise arc length control. This configuration is also expected to reduce welding operator fatigue by reducing the amount of time the welder must carry the full weight of the GTAW torches, cables, wires, etc., and is expected to reduce the level of skill required for welding personnel, permitting a welder to become proficient more quickly, and/or allowing lower-cost welders to perform a wider variety of welding operations.

During welding operation using the embodiments of the present disclosure, the filler rod can become partially welded to the weld seam at the solid/liquid boundary point. In conventional welding, the partial welding/sticking of the filler rod is detrimental to the efficiency of the welding operation as the welding operator needs to free the filler rod before continuing with the weld; however, the automated welding filler rod feeding assemblies disclosed herein can use this partial welding effect on the filler rod as a beneficial feature. In this regard, once the filler rod becomes partially welded to the workpiece at the molten pool, the advancing filler rod can transmit the feeding force back into the feeding assembly, and into the GTAW torches to advance the assembly along the weld path. In some embodiments, the feeding force acting upon the partial weld of the filler rod provides a pushing force against the GTAW torches, i.e., in the direction as if the welding operator is pulling the torch rearward along the weld path. In other embodiments the feed direction may be reversed such that the force provides a pulling motion forward along the weld path.

In use, advancing the filler rod with the feeder assembly provides an automated weld path travel speed drive mechanism, which was previously controlled manually, requiring significant welding operator skill. The automated weld path travel speed can permit welding operators to perform welds at higher travel speeds with consistent weld-quality results. In some embodiments, a 300% to 500% increase in welding speed is possible by a lower-skilled welding operator without a detrimental effect on weld quality. In some embodiments, the automated weld path travel speed (distance along the weld seam) can be about 1:1 with the filling rod feed rate. As such, some larger width or deeper welds can require more filler volume per linear distance, requiring a comparatively larger filler rod diameter. The filler rod diameter to feed speed ratio can result in more precise weld fillet size control, since the amount of filler rod added to the molten pool of the weld is more consistent at an automated weld seam travel rate. In use, the automated effect on the fillet size can reduce requirements for post-weld dimensional inspection, among other advantages. In some embodiments, larger weld fillets can be achieved by multi-pass welding (i.e., performing the welding operation on the previously welded seam again). With the anticipated speed of welding operations using the embodiments of the present disclosure, an overall efficiency is expected over manual operations where a larger weld fillet is achieved by adding more filler rod and/or traveling slower as the weld seam is traced.

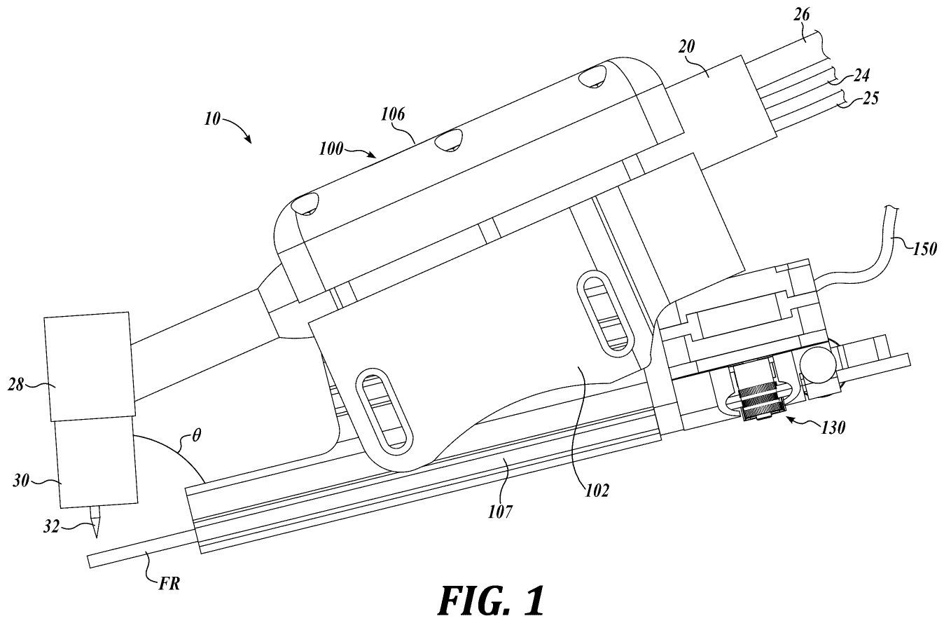

FIG. 1 is a side view of an automated welding filler rod feeding assembly 100 (the “assembly 100”) operably coupled to a handheld Gas Tungsten Arc Welding (GTAW) torch 10 (the “welding torch 10”) in accordance with embodiments of the present disclosure. The welding torch 10 is shown for reference purposes, and is intended to depict a generic GTAW torch, such as those provided by any number of GTAW torch manufacturers. In this regard, the assembly 100 can be adapted for use with any number of GTAW torch, and should not be considered limited in use to only the type of GTAW torch depicted. The welding torch 10 can include a body 20 encasing internal components and providing a user handle, one or more gas roads/paths 26, and can optionally include a water cooling send line 24, and a water cooling return line 25. The welding torch 10 can further include a torch body 28, and a ceramic cup 30, and an electrode 32 (e.g., a tungsten electrode). The gas roads/paths 26 deliver the gas from a source to the welding torch 10. The ceramic cup 30 and the electrode 32 can be configured to selectively deploy the arc energy of the welding torch 10 into the weld seam on the workpiece during use, creating the molten pool of the weld during use. As shown, a filler rod FR can be positioned with an end portion adjacent to the electrode 32 to provide the filler material for the weld bead, as will be described below.

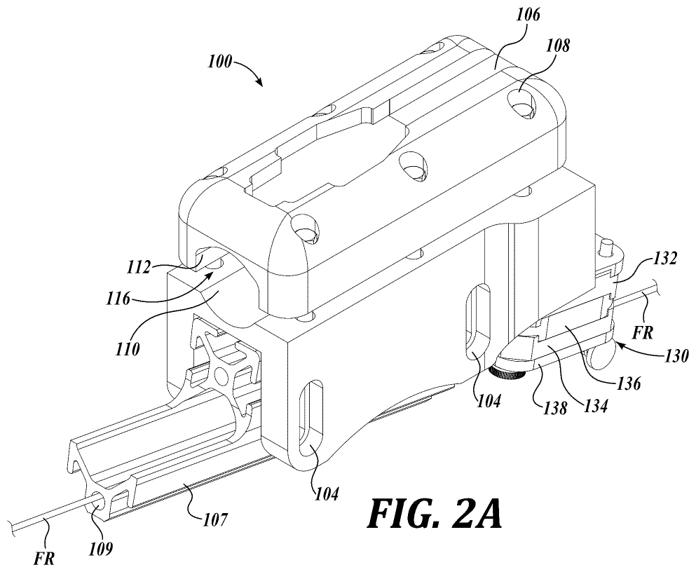

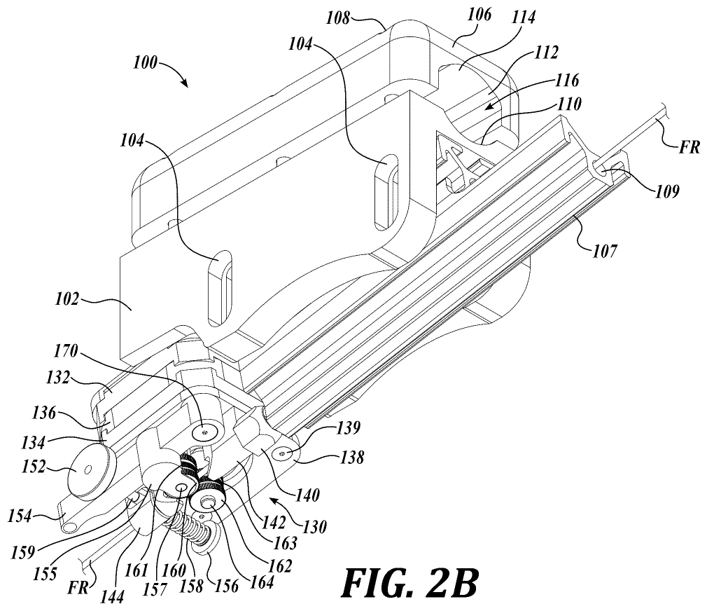

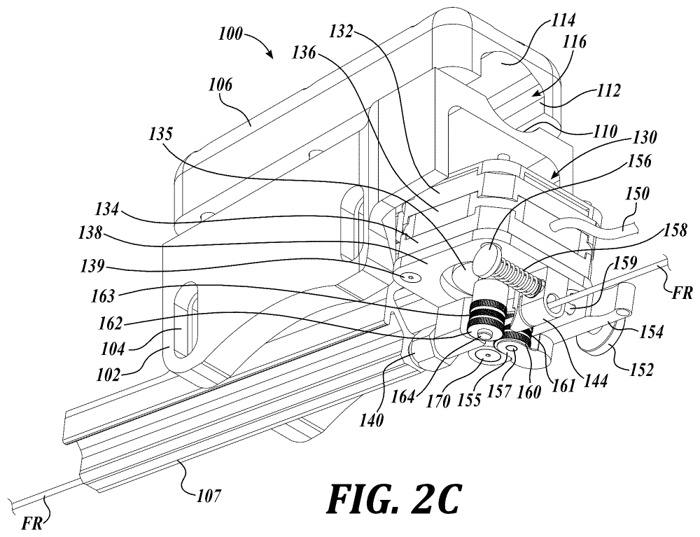

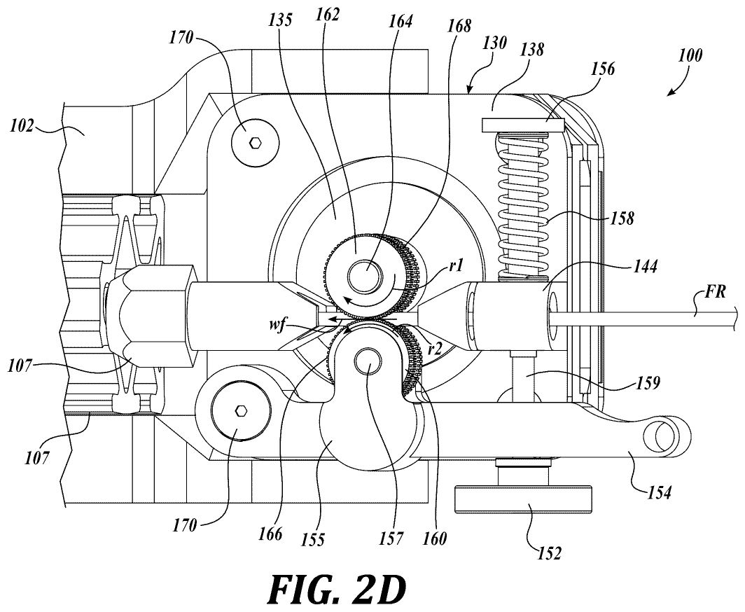

The assembly 100 can be configured to operably couple to the welding torch 10 such that the filler rod FR can be fed toward the ceramic cup 30 and the electrode 32 during welding operations. In this regard, the assembly 100 can have a main body 102, a coupling cover 106, a filler rod support extrusion 107, and a rod feeding assembly 130, which will be described in more detail below with reference to FIGS. 2A-2D. As shown, the main body 102 and the coupling cover 106 together can surround a portion of the welding torch 10 such that the assembly 100 is operably coupled to the welding torch 10 during use. The rod feeding assembly 130 can have an operational connection, e.g., to a control system (not shown), such as a control cable 150 to send electrical power to a drive motor, which can be routed similarly to an end portion of the welding torch 10, similar to the gas roads 26 and the water cooling lines 24 and 25. In this regard, a separate clip (not shown) can be used to secure the control cable 150 near the gas roads 26 for convenience purposes; however, in other embodiments, the control cable 150 of the rod feeding assembly 130 can be routed separate to the control connections of the welding torch 10, such as routed to the feeding assembly control system. Although not shown, the welding torch 10 can include further features, additional gas roads/paths, waterways, etc.

FIGS. 2A-2C are perspective views and FIG. 2D is a bottom view of the assembly 100 for the welding torch 10 in accordance with the present disclosure, shown with the filler rod FR extending through the rod feeding assembly 130 and the filler rod support extrusion 107. The main body 102 can include a central opening 116 having a bottom surface 110 and side surfaces 112, which, together with a capturing surface 114 on the bottom of the coupling cover 106, form the central opening 116 that surrounds a portion of the welding torch 10 to operably couple the assembly 100 thereto. As shown in FIGS. 2A and 2B, generally, the coupling cover 106 includes a plurality of apertures 108 configured to receive a fastener (not shown) to mount the coupling cover 106 to the main body 102, securing the welding torch 10 within the surfaces 110, 112, and 114. The main body 102 can include a plurality of slots 104 configured to receive a fastener (not shown) to adjustably mount the main body 102 to the filler rod support extrusion 107. The slots 104 can be elongated to permit adjustment of the main body 102 with respect to the filler rod support extrusion 107, e.g., to position the welding torch 10 at the desired angle with respect to the filler rod FR extending through the filler rod support extrusion 107.

As shown in FIGS. 2A-2C, a gap can exist between the coupling cover 106 in the main body 102 when assembled, and as such, the fasteners extending through the apertures 108 can be of a suitable length to permit different gaps corresponding to different heights of welding torches to be retained within the assembly 100. For example, in the embodiment shown in FIG. 1, the gap between the coupling cover 106 in the main body 102 is small, representing a shorter height welding torch 10. The surfaces 110, 112, and 114 securing the welding torch 10 within the central opening 116 can include materials to improve the grip against and/or protect the surfaces of the welding torch 10, such as rubber, felt, foam, etc. and can be applied adhesively, with fasteners, and/or with mechanical retention features (clips, snaps, press-fit, etc.). These materials can also adapt the assembly 100 for use with smaller welding torches than the illustrated embodiment.

The main body 102 can be configured to mount the rod feeding assembly 130 to the main body 102 at a distance providing the desired convergence angle θ of the filler rod FR with the nozzle 30 of the welding torch 10. The convergence angle θ can be from about 10° to about 90°, from about 45° to about 90°, from about 70° to about 90°, or about 80°. In some embodiments, the rod feeding assembly can be operably coupled to the filler rod support extrusion 107, which is operably coupled to the main body 102. In these embodiments, the main body 102 can be adapted for interfacing with the rod feeding assembly 130 to prevent movement of the welding torch 10 with respect to the assembly 100, and ultimately with respect to the filler rod FR.

With reference to FIGS. 2A-2C, the components of the rod feeding assembly 130 will now be described in detail. As shown, the rod feeding assembly 130 can have an upper plate 132 configured to interface with the lower end of the extension portion 104, and a lower plate 134 positioned on an opposite side of a drive motor body 136 (the “drive motor 136” having, e.g., a stator, windings, at least one rotor, permanent magnet, etc.) from the upper plate 132. In this assembly, the upper and lower plate 132 and 134 sandwich the drive motor 136 therebetween, forming a drive motor assembly. The drive motor 136 can be controlled by the control cable 150, which can be electrically coupled to the control system (not shown) and selectively send electrical power to the drive motor 136 based on, e.g., welding operator settings, automatic control settings, or any combination thereof. In some examples, the welding operator can specify any number of the type of weld, the alloy to be welded, the alloy of the filler rod, the diameter of the filler rod, the GTAW torch settings, the desired fillet size, among other relevant parameters, and the control system will set the feed rate of the filler rod FR in the rod feeding assembly 130 to accommodate the desired performance of the welding system. The rod feeding assembly 130 can further include a bottom plate 138 positioned on a lower end of the lower plate 134, and a plurality of fasteners 139 extending through the bottom plate 138, the lower plate 134, the drive motor 136, the upper plate 132, and into the extension portion 104 of the main body 102. The sandwich configuration of the plates 132, 134, and 136 provide stability and support to the drive motor 136 with respect to the main body 102 and provide mounting support for components feeding the filler rod FR to the welding torch 10. The drive motor 136 can be any suitable motor configured to advance the filler rod FR through the rod feeding assembly 130. In some embodiments, the drive motor 136 can be a stepper type motor configured to provide precise positioning of the motor shaft in response to a control signal

Turning to FIG. 2B, the rod feeding assembly 130 can further include a first rod support tube 142 having a compression nut 140, and a second rod support tube 144 axially aligned with the first rod support tube 142 such that the filler rod FR can extend through the support tubes 142 and 144 and exit from the compression nut 140 toward the ceramic cup 30 of the welding torch 10. In some embodiments, a sleeve (not shown) can be inserted into one or both of the support tubes 142 and 144 to protect the filler rod FR during travel therethrough, such as low friction sleeves with different opening sizes. In these embodiments, the compression nut 140 can retain the sleeve within the first rod support tube 142 during feeding of the filler rod FR.

The filler rod FR can be advanced through the support tubes 142 and 144 by the drive motor 136, which includes a rotating drive shaft 164 operably coupled to a drive gear 162. An opposing support idler gear 160 can be positioned on an opposite side of the filler rod FR from the drive gear 162 to apply pressure to the drive gear 162, creating friction with the filler rod FR to grip and advance the filler rod FR through the support tubes 142 and 144. In this regard, the idler gear 160 can have gripping teeth 161, and the drive gear 162 can have gripping teeth 163. The gripping teeth 161 and 163 together can interface with the filler rod FR such that a rotation of the drive motor 136 and thereby the rotating drive shaft 164 will grip and advance the filler rod FR. As the filler rod FR advances out of the support tube 142, it passes into a filler rod aperture 109 of the filler rod support extrusion 107. The filler rod aperture 109 is configured to provide support of the filler rod between the rod feeding assembly 130 and the electrode 30 of the welding torch 10. In this regard, the welding personnel are permitted to use the filler rod FR to support the assembly 100 during welding operations, where the filler rod FR will bear on the filler rod aperture 109 to support the weight of the assembly 100 and the hand/arm of the welding operator. As noted elsewhere in the present disclosure, the disclosed configuration, where the weight of the GTAW torch, feeding assembly, and filler rod can generally be supported by the filler rod atop the workpiece, permits the welding operator to precisely control the arc length, improving weld joint consistency and performance.

As shown most clearly in FIG. 2D, a tensioning system can be used to provide variable pressure of the idler gear 160 against the filler rod FR, which in turn forces the filler rod FR against the gripping teeth 163 of the drive gear 162. The tensioning system can include a tensioning lever 154 that pivots around a fastener 170 that can extend through the rod feeding assembly 130 and into the main body 102 similarly the fasteners 139. The tensioning lever 154 can have an idler gear support portion 155 for carrying the idler gear, e.g., by a gear pin 157. The tensioning system can be adjusted by a tension knob 152 which can be manipulated to rotate a tension shaft 159 extending through a portion of the second rod support tube 144. The tension shaft 159 can be threadably associated on an opposite end from the tension knob 152 with an adjuster collar 156, and can include a biasing spring 158 extending between the adjuster collar 156 and the second rod support tube 144. During use, the biasing spring 158 provides a force against the adjuster collar 156 away from the second rod support tube 144, creating a tension force in the tension shaft 159, pivoting the tensioning lever 154 about the fastener 170 and pressing the idler gear 160 against the filler rod FR.

As the tension knob 152 is rotated, the position of the adjuster collar 156 with respect to the second rod supports two 144 changes, thereby changing the length of the biasing spring 158. When the tension knob 152 is rotated such that the biasing spring 158 shortens, a greater force is applied against the filler rod FR by the idler gear 160. When the tension knob 152 is rotated such that the biasing spring 158 lengthens, a smaller force is applied against the filler rod FR by the idler gear 160. The pressure of the idler gear 160 against the filler rod FR, and thereby against the drive gear 162, can be controlled such that the filler rod FR does not slip with respect to the gripping teeth 163 of the drive gear 162. During feeding by the rod feeding assembly 130, the drive shaft 164 rotates clockwise, rotating the drive gear 162 in the direction of arrow r1. Coupled with the pressure of the filler rod FR against the gripping teeth 163 of the drive gear 162, the rotation of the drive gear 162 by the drive motor 136 in the direction of the arrow r1 causes an advancing of the filler rod in a wire feed direction wf. The contact of the gripping teeth 161 of the idler gear 160 also causes a counterclockwise rotation of the idler gear 160 in the direction of arrow r2 about the gear pin 157. As can be seen in FIG. 2D, the higher the force of the biasing spring 158, the higher the pressure between the drive gear 162 and the idler gear 160, causing higher friction on the filler rod FR; however, too high of pressure between the gears 160 and 162 can damage the filler rod FR and/or cause premature wear of the components of the rod feeding assembly 130 (e.g., bearings, bushings, sleeves, the drive motor 136, etc.). As such, the tension knob 152 can be rotated to the point where the filler rod FR does not slip with respect to the drive gear 162 for the alloy and size of filler rod FR used during the welding operation.

The embodiments of the present disclosure permit use of standard and readily available filler rod straight lengths (e.g., 36″ rods), which increases availability of filler rod material for welding operation use with the assembly 100. In other embodiments, the filler material can be a wire delivered by a remote wire feeding suitcase, feeding from a spool of wire. Filler wire spools are widely available in the industry, but lack the structural support to utilize the filler material as a resting component for the welding torch 10, assembly 100, and the hand/arm of the welder. The rod feeding assembly 130 is configured such that the feeder rods FR can be readily removed and/or loaded into the assembly for welding operations using different diameters and metal alloys.

In the foregoing description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 10% of the stated value. For the purposes of the present disclosure, the phrase “at least one of A and B” is equivalent to “A and/or B” or vice versa, namely “A” alone, “B” alone, or “A and B.” Similarly, the phrase “at least one of A, B, and C,” for example, means (A), (B), (C), (A and B), (A and C), (B and C), or (A, B, and C), including all further possible permutations when greater than three elements are listed.

It should be noted that for purposes of this disclosure, terminology such as “upper,” “lower,” “vertical,” “horizontal,” “fore,” “aft,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

The embodiments of the invention in which an exclusive property or privilege is claimed are defined as follows:

1. An automated welding filler rod feeding assembly for operably coupling to a handheld welding torch and feeding a filler rod thereto, the assembly comprising:
a main body having a central opening with a bottom surface and side surfaces;
a coupling cover removably couplable to the main body adjacent to the side surfaces, the coupling cover having a capturing surface positioned opposite the bottom surface when the coupling cover is assembled to the main body, the capturing surface together with the bottom and side surfaces configured to at least partially surround and retain the handheld welding torch therein; and
a rod feeding assembly operably coupled to the main body and comprising:
a first rod support tube and a second rod support tube axially aligned with each other and configured to translate the filler rod therethrough;
a drive motor having a drive shaft and a drive gear fixed to the drive shaft, the drive gear positioned abutting the filler rod between the first rod support tube and the second rod support tube; and
an idler gear positioned abutting the filler rod opposite from the drive gear, the idler gear imparting a biasing force against the filler rod toward the drive gear for increasing friction between the drive gear and the filler rod,
wherein rotation of the drive gear by the drive motor causes the filler rod to advance axially through the first and second rod support tubes.

2. The assembly of claim 1, further comprising a filler rod support extrusion operably coupled to the main body, wherein the filler rod support extrusion has a filler rod aperture axially aligned with the first and second rod support tubes and through which the filler rod extends toward an electrode of the handheld welding torch, wherein the filler rod aperture is configured to provide support of the filler rod between the rod feeding assembly and the electrode of the handheld welding torch.

3. The assembly of claim 2, wherein the filler rod support extrusion is adjustably coupled to the main body to form a variable convergence angle of the filler rod with the electrode of the handheld welding torch, and wherein the convergence angle is from about 10° to about 90°, from about 45° to about 90°, from about 70° to about 90°, or about 80°.

4. The assembly of claim 1, wherein the drive motor further comprises an upper plate positioned between the main body and the drive motor, and a lower plate positioned between the drive motor and the first and second rod support tubes, the upper plate, drive motor, and the lower plate forming a drive motor assembly.

5. The assembly of claim 4, wherein the rod feeding assembly further comprises a bottom plate fixed to the lower plate, and wherein the first and second rod support tubes are operably coupled to the bottom plate.

6. The assembly of claim 1, wherein the idler gear is rotatably coupled to a lever at an intermediate position along the lever, wherein the lever is pivotable at a first end of the lever with respect to the drive gear.

7. The assembly of claim 6, further comprising a tension shaft extending through the lever on an opposite side of the idler gear from the first end, wherein the tension shaft is adjustably coupled to a collar and a spring configured to bias the idler gear against the filler rod toward the drive gear.

8. The assembly of claim 7, wherein the tension shaft comprises a tension knob rotatable to change the length of the spring and adjust the biasing force of the spring on the lever, thereby adjusting the biasing force of the idler gear against the filler rod toward the drive gear.

9. The assembly of claim 1, wherein the drive gear further comprises a plurality of gripping teeth positioned around a circumference of the drive gear at an interface point with the filler rod, wherein the gripping teeth are configured to increase friction between the drive gear and the filler rod.

10. The assembly of claim 1, wherein the handheld welding torch is a handheld gas tungsten arc welding (GTAW) torch.

11. An automated welding system having a filler rod feed, the automated welding system comprising:
a handheld welding torch having an electrode tip portion configured to create a molten pool along a weld path;
a filler rod feeding assembly, comprising:
a main body having a central opening with a bottom surface and side surfaces;
a coupling cover removably couplable to the main body adjacent to the side surfaces, the coupling cover together with the bottom and side surfaces configured to at least partially surround and retain the handheld welding torch therein; and
a rod feeding assembly operably coupled to the main body and comprising:
a first rod support tube and a second rod support tube axially aligned with each other and configured to translate the filler rod therethrough;
a drive motor having a drive shaft and a drive gear fixed to the drive shaft, the drive gear positioned abutting the filler rod between the first rod support tube and the second rod support tube; and
an idler gear positioned abutting the filler rod opposite from the drive gear, the idler gear imparting a biasing force against the filler rod toward the drive gear for increasing friction between the drive gear and the filler rod,
wherein rotation of the drive gear by the drive motor causes the filler rod to advance axially through the first and second rod support tubes to the electrode tip portion of the handheld welding torch.

12. The automated welding system of claim 11, further comprising a filler rod support extrusion operably coupled to the main body, wherein the filler rod support extrusion has a filler rod aperture axially aligned with the first and second rod support tubes and through which the filler rod extends toward an electrode of the handheld welding torch, wherein the filler rod aperture is configured to provide support of the filler rod between the rod feeding assembly and the electrode of the handheld welding torch.

13. The automated welding system of claim 12, wherein the filler rod support extrusion is adjustably coupled to the main body to form a variable convergence angle of the filler rod with the electrode of the handheld welding torch, and wherein the convergence angle is from about 10° to about 90°, from about 45° to about 90°, from about 70° to about 90°, or about 80°.

14. The automated welding system of claim 11, wherein the drive motor further comprises an upper plate positioned between the main body and the drive motor, and a lower plate positioned between the drive motor and the first and second rod support tubes, the upper plate, drive motor, and the lower plate forming a drive motor assembly.

15. The automated welding system of claim 14, wherein the rod feeding assembly further comprises a bottom plate fixed to the lower plate, and wherein the first and second rod support tubes are operably coupled to the bottom plate.

16. The automated welding system of claim 11, wherein the idler gear is rotatably coupled to a lever at an intermediate position along the lever, wherein the lever is pivotable at a first end of the lever with respect to the drive gear.

17. The automated welding system of claim 16, further comprising a tension shaft extending through the lever on an opposite side of the idler gear from the first end, wherein the tension shaft is adjustably coupled to a collar and a spring configured to bias the idler gear against the filler rod toward the drive gear.

18. The automated welding system of claim 17, wherein the tension shaft comprises a tension knob rotatable to change the length of the spring and adjust the biasing force of the spring on the lever, thereby adjusting the biasing force of the idler gear against the filler rod toward the drive gear.

19. The automated welding system of claim 11, wherein the drive gear further comprises a plurality of gripping teeth positioned around a circumference of the drive gear at an interface point with the filler rod, wherein the gripping teeth are configured to increase friction between the drive gear and the filler rod.

20. The automated welding system of claim 11, wherein the handheld welding torch is a handheld gas tungsten arc welding (GTAW) torch.
